(19) United States
(12) Patent Application Publication
(10) Pub. No.: US 2016/0048745 A1
(43) Pub. Date: Feb. 18, 2016

(54) IMAGE FORMING APPARATUS, METHOD OF DRIVING THE SAME, AND COMPUTER READABLE RECORDING MEDIUM

(71) Applicant: Samsung Electronics Co., Ltd., Suwon-si (KR)

(72) Inventors: Hyo-su JEONG, Daegu (KR); Jin-hwi Jun, Suwon-si (KR)

(73) Assignee: Samsung Electronics Co., Ltd., Suwon-si (KR)

(21) Appl. No.: 14/789,280

(22) Filed: Jul. 1, 2015

(30) Foreign Application Priority Data
Aug. 14, 2014 (KR) 10-2014-0106241

(51) Int. Cl. G06K 15/02

(52) U.S. Cl. CPC G06K 15/18

(57) ABSTRACT

An image forming apparatus is provided. The image forming apparatus includes a master unit configured to detect a data capturing timing by using data information received with being synchronized with an arbitrary clock in response to a request for data information with respect to a slave unit and use the detected data capturing timing to capture data of the slave unit and a slave unit configured to provide the data information which is synchronized with an arbitrary clock in response to a request for data information from the master unit.

### CROSS-REFERENCE TO RELATED APPLICATIONS

This application claims the priority benefit from Korean Patent Application No. 10-2014-0106241, filed on Aug. 14, 2014 in the Korean Intellectual Property Office, the disclosure of which is incorporated herein by reference in its entirety.

### BACKGROUND

1. Field

Embodiments relate generally relate to at least one of an image forming apparatus, a method of driving an image forming apparatus, and a computer readable recording medium, and more particularly, to an image forming apparatus which uses an actual measurement value in performing Serial Peripheral Interface (SPI) communication thereby securing a reliable data capturing timing and implementing optimized SPI efficiency, a method of driving an image forming apparatus, and a computer readable recording medium.

2. Description of the Related Art

In general, SPI communication is commonly used to perform functions of a memory, a facsimile, a MODEM, and a Wireless-Fidelity (Wi-Fi) interface in a printer and a multifunctional device. The SPI provides relatively higher speed than an interface such as Universal Asynchronous Receiver and Transmitter (UART) and Inter-Integrated Circuit (12C). However, the SPI does not have dedicated Input/Output (I/O) and a physical (Phy) layer and has merits of being controlled through General-purpose Input/Output (GPIO). In such SPI communication, a data capturing timing is considered very important due to the high speed and deviation between corners of a chip.

In the related art, a total delay is calculated by corner through Static Timing Analysis (STA) in a lay-out stage when implementing Application-Specific Integrated Circuit (ASIC). Based on the total delay, a capturing timing value which may be commonly used in each corner is obtained. After an actual chip is manufactured, a timing value is set through software (SW), and it is determined whether the timing value is consistent with a value obtained by performing STA with respect to the actual chip.

A method of obtaining a data capturing timing through STA needs to satisfy both of an example where the timing is a minimum (MIN) value and an example where the timing is a maximum (MAX) value. In order to satisfy both examples, a minimum value and a maximum value of a total day in each route are obtained. The total delay is obtained by adding a route delay within a chip, a Printed Circuit Board (PCB) delay, and a slave device delay. Since the PCB delay and the slave device delay are not known in the STA stage, a maximum delay and a minimum delay are calculated higher than actual maximum delay value and minimum delay value. In response to a difference between the maximum delay value and the minimum delay value of the total delay being greater than a single cycle of a SPI clock in the chip, the SPI clock is driven at a speed reduced to a commonly usable speed, not a maximum speed which is providable by a SPI master, in order to obtain a common capturing timing value which satisfies a predetermined condition. Thus, data transmission performance deteriorates.

A clock frequency in the chip may vary depending upon implementation of a low power characteristic or a clock generating procedure. As such, every time a frequency of an inner clock is changed, a valid data capturing timing needs to be set by obtaining an operation frequency by reading registers related to generation of the clock, that is, reading information, through the SW and considering a relation with a delay. Accordingly, there is a problem that a system bus clock cannot be changed immediately, and the operations should be controlled by considering a relation between the entire delays and a clock in the SW in order to set a SPI timing.

### SUMMARY

One or more embodiments address the aforementioned and other problems and disadvantages occurring in the related art. In an aspect of In an aspect of one or more embodiments, there is provided an image forming apparatus, a method of driving an image forming apparatus, and a computer readable recording medium, and more particularly, to an image forming apparatus which uses an actual measurement value in performing SPI communication thereby securing a reliable data capturing timing and implementing optimized SPI efficiency, a method of driving an image forming apparatus, and a computer readable recording medium.

In an aspect of one or more embodiments, there is provided an image forming apparatus which includes a master unit configured to detect a data capturing timing by using data information received with being synchronized with an arbitrary clock in response to a request for data information for a slave unit and configured to use the detected data capturing timing to capture data of the slave unit and the slave unit configured to provide the data information which is synchronized with the arbitrary clock in response to the request for data information from the master unit.

The master unit and the slave unit may perform Serial Peripheral Interface (SPI) communication. In addition, in response to the slave unit being a storage, the master unit may read data transmitted from the master unit and stored in the slave unit and use the data as the data information.

In response to the slave unit being incapable of storing data, the master unit may use apparatus identification (ID) stored in the slave unit or address information stored in the slave unit as the data information.

In response to change of an inner clock of the image forming apparatus or in response to selection of the slave unit, the master unit may detect the data capturing timing.

The master unit may use data which belongs to the same address in order to detect the data capturing timing.

The image forming apparatus may further include a controller configured to control the master unit. In addition, the master unit may receive a signal regarding the change of the inner clock or the selection of the slave unit from the controller.

The master unit may detect a plurality of data capturing timings and use one of the plurality of detected data capturing timings as a valid data capturing timing.

The master unit may include a clock generator configured to generate clocks in different cycles and detects the data capturing timing of the generated clocks by cycles by using the data information.

The master unit may pre-store second data information which is the same as the data information and detect a data capturing timing by receiving the data information with changing a data capturing timing and comparing the received data information with the pre-stored second data information.

In an aspect of one or more embodiments, there is provided a method which includes requesting data information from a slave unit, detecting a data capturing timing by using the data information which is received with being synchronized with an arbitrary clock in response to the request, and using the detected data capturing timing to capture data of the slave unit.

The method may further include storing second data information which is the same as the data information and comparing the received data information with the stored second data information. In addition, the detecting the data capturing timing may include detecting a timing when the received data information is consistent with the stored second data information as the data capturing timing.

A master unit and the slave unit may perform Serial Peripheral Interface (SPI) communication. In addition, the detecting the data capturing timing may include reading data transmitted from the master unit and stored in the slave unit and using the data as the data information.

In response to the slave unit being incapable of storing data, the detecting the data capturing unit may include using apparatus identification (ID) stored in the slave unit or address information stored in the slave unit as the data information.

In response to change of an inner clock of the image forming apparatus or in response to selection of the slave unit, the detecting the data capturing unit may include detecting the data capturing timing.

The detecting the data capturing timing may include using data which belongs to the same address in order to detect the data capturing timing.

The method may further include receiving a signal regarding the change of the inner clock or the selection of the slave unit from an external source by the master unit.

The detecting the data capturing timing may include detecting a plurality of data capturing timings and determining one of the plurality of detected data capturing timings as a valid data capturing timing.

The method may further include generating clocks in different cycles. In addition, the detecting the data capturing timing may include detecting the data capturing timing of the generated clocks by cycles by using the data information.

In an aspect of one or more embodiments, there is provided a computer readable recording medium including a program for executing a method of driving an image forming apparatus according to an exemplary embodiment includes requesting for data information to a slave unit, detecting a data capturing timing by using data information which is received with being synchronized with an arbitrary clock in response to the request, and using the detected data capturing timing to capture data of the slave unit.

In an aspect of one or more embodiments, there is provided at least one non-transitory computer readable medium storing computer readable instructions to implement methods of one or more embodiments.

### BRIEF DESCRIPTION OF THE DRAWINGS

The above and/or other aspects will be more apparent by describing exemplary embodiments with reference to the accompanying drawings, in which:

FIG. 1 is a block diagram illustrating an example of a structure of an image forming apparatus according to an exemplary embodiment;

FIG. 2 is a diagram provided to describe a timing calibration unit which operates as a master unit and a storage which operates as a slave unit of FIG. 1 according to an exemplary embodiment;

FIG. 3 is a block diagram illustrating an example of a structure of a data calibration unit when the storage of FIG. 1 operates as a slave unit according to an exemplary embodiment;

FIG. 4 is a diagram illustrating an example of a structure of a packet which is transmitted from the master unit to the slave unit of FIG. 2;

FIG. 5 is a diagram illustrating a status of calibration information stored in the storage of FIG. 1 or in a memory of a data generator of FIG. 3;

FIG. 6 is a diagram provided to describe a process of capturing data by changing a capturing timing;

FIG. 7 is a diagram provided to describe a process of differently setting a capturing timing according to an actual delay of a chip;

FIGS. 8A and 8B are diagrams provided to describe a process of changing a clock cycle by considering a temperature change;

FIGS. 9A and 9B are diagrams provided to describe a process of determining a valid capturing timing according to a change of a clock cycle;

FIG. 10 is a flowchart provided to describe a method of driving an image forming apparatus according to an exemplary embodiment;

FIG. 11 is a flowchart provided to describe an operating process of an image forming apparatus which operates in a polling mode according to an exemplary embodiment;

FIG. 12 is a flowchart provided to describe an operating process of an image forming apparatus which operates in an interrupting mode according to an exemplary embodiment; and

FIG. 13 is a flowchart provided to describe an operating process of an image forming apparatus according to an exemplary embodiment.

### DETAILED DESCRIPTION

Reference will now be made in detail to embodiments, examples of which are illustrated in the accompanying drawings, wherein like reference numerals refer to the like elements throughout. Embodiments are described below by referring to the figures.

The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

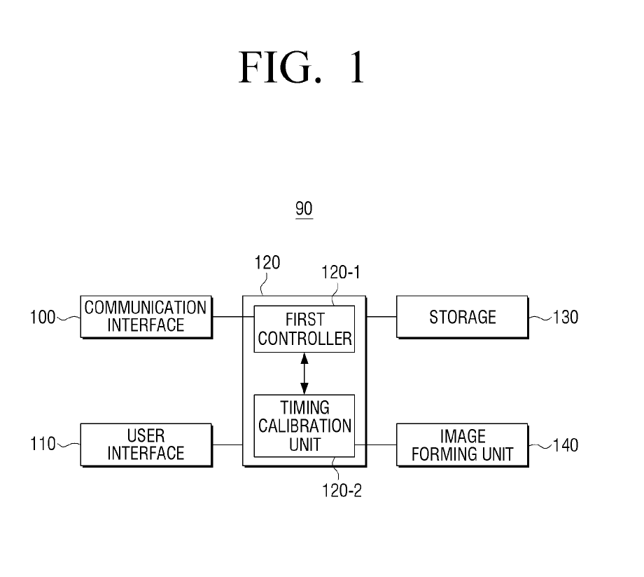

FIG. 1 is a block diagram illustrating an example of a structure of an image forming apparatus according to an exemplary embodiment.

As shown in FIG. 1, an image forming apparatus 90 according to an exemplary embodiment refers to an apparatus including a printer, a multifunctional device, a scanner, and the like. The image forming apparatus 90 includes a part or all of a communication interface 100, a user interface 110, a controller 120, a storage 130, and an image forming unit 140.

In an example, including a part or all of components indicates that a part of components, for example, the storage 130, is omitted or integrated with the other component, for example, the image forming unit 140. Herein, it is described that the image forming apparatus 90 includes all of the components for better understanding of exemplary embodiments.

The communication interface 100 performs communication by being connected to a terminal device such as a computer or a mobile phone and may receive printing data provided from the terminal device, more particularly, printing option-related information. According to an exemplary embodiment, the communication interface 100 may include a facsimile, a MODEM, and a local area communication unit for performing wireless communication (e.g. Wi-Fi communication). According to an exemplary embodiment, at least one of the facsimile, the MODEM, and the local area communication unit for performing the Wi-Fi communication may operate as a slave unit of a timing calibration unit 120-2 which operates as a master unit in order to perform the SPI communication.

The user interface 110 includes a button which receives a user command, for example, a power button. The user interface 110 may further include a display which shows a printing setting and a printing status. In an example of a display being implemented as a touch screen, a user command may be received through the display. According to an exemplary embodiment, the display provides a user interface (UI) screen where a user is able to determine which clock cycle the user will use. In addition, the display may receive a user command through the provided UI screen.

The controller 120 controls overall operations of the communication interface 100, the user interface 110, the storage 130, and the image forming unit 140 constituting the image forming apparatus 90. For example, the controller 120 may temporarily store printing data received through the communication unit 100 in the storage 130, or read and output the stored data on a paper through the image forming unit 140. In this example, the controller 120 may perform an image forming operation according to a user command received through the user interface 110. In addition, in order to perform the SPI communication, the controller 120 may operate the timing calibration unit 120-2 in the apparatus. For this operation, the controller 120 may determine whether the image forming apparatus 90 is booted up at an initiatory stage or whether a mode of the apparatus is switched to a power saving mode. In addition, the controller 120 may determine which operation unit is selected. For example, the controller 120 may control the timing calibration unit 120-2 to operate with a particular operation unit, for example, the communication interface 100 or the storage 130.

The controller 120 may include a first controller 120-1 which operates as a main controller and the timing calibration unit 120-2. It is preferred that the first controller 120-1 and the timing calibration unit 120-2 are placed within a single chip, but not limited thereto. The first controller 120-1 controls inner components in the common communication environment. Unlike the first controller 120-1, the timing calibration unit 120-2 may operate in response to a request for calibration of a data capturing timing. That is, the timing calibration unit 120-2 performs communication, for example, the SPI communication, with the communication interface 100 which performs a particular function like an adjacent operation unit, for example, a facsimile, a MODEM, and a Wi-Fi interface, or the storage 130 which stores data. Through the communication operation, the timing calibration unit 120-2 captures data by calibrating various delay factors which occur in a chip manufacturing process. That is, the timing calibration unit 120-2 brings data. In this example, the delay factor refers to delay which occurs in a data processing operation. For example, in response to determining that there is a delay corresponding to a cycle or the number of clocks of a certain clock when the timing calibration unit 120-2 reads the data stored in the storage 130, the timing calibration unit 120-2 captures data by calibrating the data as much as the determined delay value. In this example, the calibration may refer to an operation of reading data by changing a data capturing timing. A detailed description will be provided below.

The storage 130 may temporarily store printing data received through the communication interface 100 under control of the controller 120 and further store data information to be compared with data read from a flash memory, for example, to calibrate a capturing timing. The storage 130 may store data information, such as apparatus ID or address information, provided in response to a request to the communication interface 100 such as a MODEM or a facsimile. According to an exemplary embodiment, the storage 130 may include a flash memory for performing the SPI communication. In response to the storage 130 being a flash memory which performs the SPI communication or in response to the storage 130 including the flash memory, the timing calibration unit 120-2 may be synchronized with an arbitrary clock, record transmitted data in the flash memory, read the recorded data again, and use the read data for detecting a data capturing timing. In addition, the timing calibration unit 120-2 may calibrate a previous capturing timing by using the detected capturing timing and read the data stored in the storage 130.

The image forming unit 140 may include a printing unit, a scanning unit, and the like. The image forming unit 140 may print out print data on a paper through the printing unit and scan an inputted document through the scanning unit. Scanned image data may be transferred to an external apparatus through the communication interface 100.

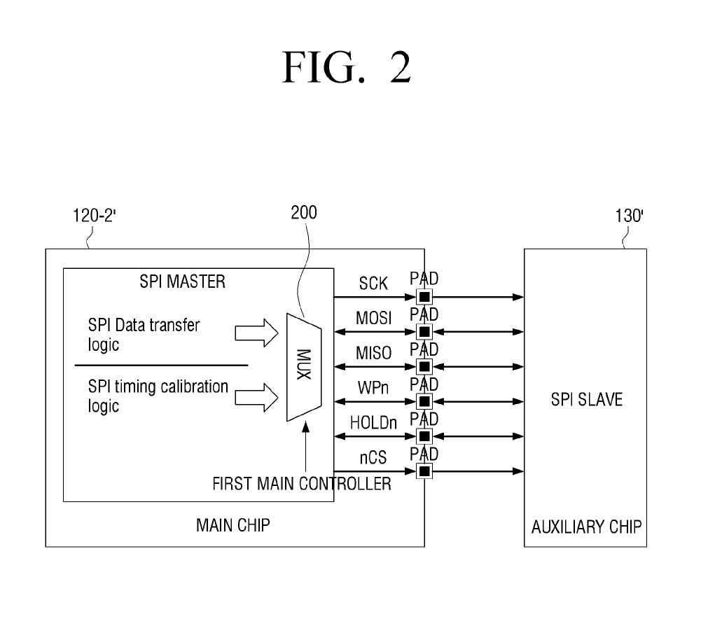

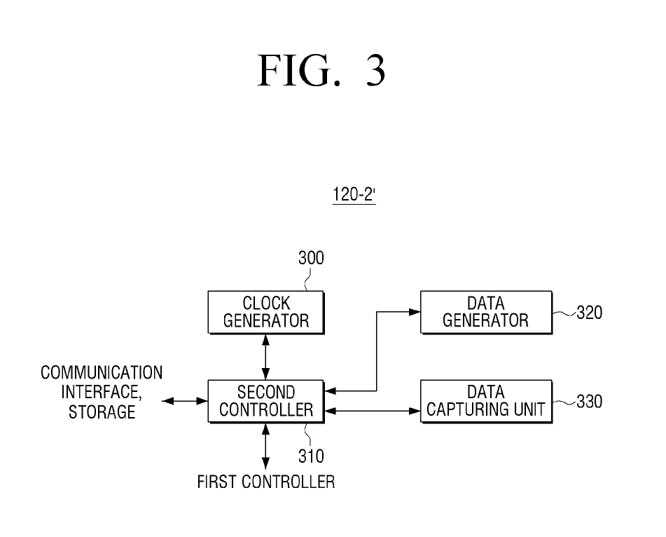

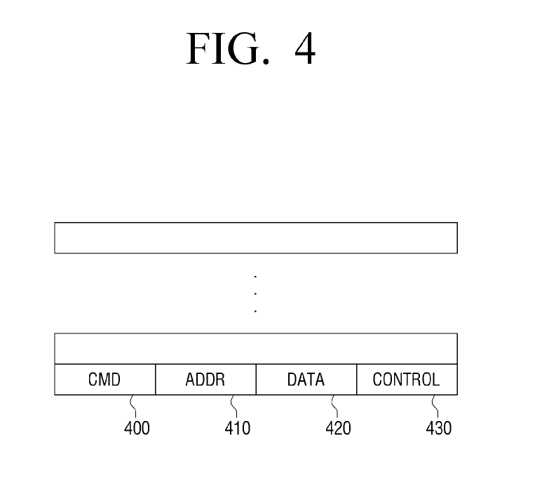

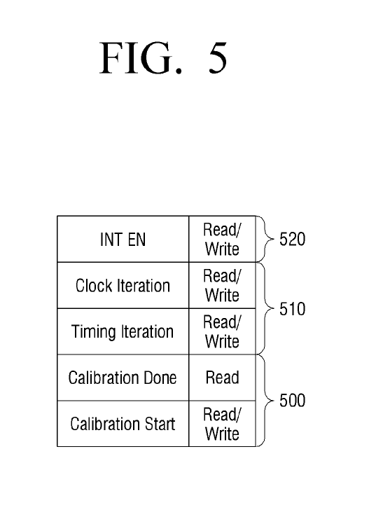

FIG. 2 is a diagram provided to describe a timing calibration unit which operates as a master unit and a storage which operates as a slave unit of FIG. 1 according to an exemplary embodiment, FIG. 3 is a block diagram illustrating an example of a structure of a data calibration unit when the storage of FIG. 1 operates as a slave unit, and FIG. 4 is a diagram illustrating an example of a structure of a packet which is transmitted from the master unit to the slave unit of FIG. 2. In addition, FIG. 5 is a diagram illustrating a status of calibration information stored in the storage of FIG. 1 or in a memory of a data generator of FIG. 3.

Referring to FIGS. 2 and 3 with FIG. 1, the timing calibration unit 120-2 of FIG. 1 according to an exemplary embodiment may operate as a master unit 120-2′ for performing the SPI communication, and the storage 130 of FIG. 1 may operate as a slave unit 130′, for example.

According to an exemplary embodiment, the timing calibration unit 120-2 and the storage 130 may perform communication as a SPI master and a SPI slave for transmitting/receiving data by using a SPI protocol and perform effective communication through calibration of a data capturing timing. The timing calibration unit 120-2 which operates as the master unit 120-2′ may be a sort of hardware which finds an appropriate timing value when recording or reading data in/from the storage 130 which operates as the slave unit 130′.

The SPI communication is performed in a master mode or in a slave mode, and four types of logical signals are designated and used for the SPI communication. In this example, the four types of logical signals refer to Negative Slave Select (NSS) that is a signal for selecting a slave, Serial Clock (SCLK) that is a signal for transmitting a clock in a master, Master Input Slave Output (MISO) that is an input signal with respect to the master, and Master Output Slave Input (MOSI) that is an output signal with respect to the master.

In FIG. 2, in a chip (e.g. main chip)constituting the master unit 120-2′, the Serial Clock (SCK) is a signal terminal which supplies a clock for operating Serial Flash, Serial Input (SI) is a signal terminal where data and an address are inputted to the Serial Flash, and Serial Output (SO) is a signal terminal where the data is outputted from the Serial Flash. The Write Protect (WP) is a signal terminal for prohibiting a writing operation, and Hold is a signal terminal for pausing an operation of the Serial Flash.

The SPI records and reads data in/from the slave unit 130′ with reference to a SPI clock generated as the master unit 120-2′ generates a clock. The SPI sends transmission data in response to Tx with reference to a SPI clock. In response to Rx with reference to the SPI clock, the slave unit 130′ receives and sends the SPI clock.

In such process, if a chip is designed such that a route delay that a clock moves towards the slave unit 130′ becomes equal to a route delay that data moves towards the slave unit 130′ in an example of Tx, Tx data may be stored in the slave unit 130′ without any problem. By contrast, in an example of Rx, data comes in after the delay that a clock moves towards the slave unit 130′, a delay that data goes out of the slave unit 130′, and a delay that data enters the master unit 120-2′ from the slave unit 130′. Accordingly, in view of the SPI master, a point of time of capturing data is considered important in capturing valid data.

For the above operation, the master unit 120-2′ according to exemplary embodiment further includes a part for calibrating a SPI timing in a part for transmitting the SPI data. More particularly, as shown in FIG. 3, the master unit 120-2′ may include a part or all of a clock generator 300, a second controller 310, a data generator 320, and a data capturing unit 330. The master unit 120-2′ may further include, for example, a multiplexer 200 as a switching unit, as shown in FIG. 2. In this example, the clock generator 300 and the data generator 320 may be involved in data transmission, and the data capturing unit 330 may be involved in timing calibration.

Herein, including a part or all of components indicates that a part of the components, such as the clock generator 300 and the data generator 320, may be omitted according to a type of the slave unit 130′ which performs operation with the master unit 120-2′. Herein, in this example, it is described that the master unit 120-2′ includes all of the components for a better understanding of an exemplary embodiment.

For example, the clock generator 300 may include a clock generator, such as an oscillator, for generating a clock. The clock generator 300 outputs the generated clock under the control of the second controller 310.

The second controller 310 may operate in response to a request of the first controller 120-1 shown in FIG. 1 and control overall operations of the clock generator 300, the data generator 320, and the data capturing unit 330. For example, in generating and transmitting data, the second controller 310 synchronizes the data with a clock generated in the clock generator 300 and transmits the data generated in the data generator 320. That is, the second controller 320 transmits the data to the storage 130 which operates as the slave unit 130′. In addition, in order to calibrate a capturing timing by using the data read from the storage 130, the second controller 310 may control such that the data capturing unit 330 operates.

The data generator 320 generates data for transmitting to the storage 130 which operates as the slave unit 130′. For example, the data generator 320 may generate data which is synchronized with a clock generated in the clock generator 300. For this operation, the data generator 320 may include a timer or a counter.

For example, a packet which is transmitted from the master unit 120-2′ to the slave unit 130′ may be formed of CMD 400, ADDR 410, and DATA 420 as shown in FIG. 4 and may further require control 430 with respect to the packet. Packet required for a calibration process varies depending upon a type of the slave unit 130′, and thus, information on the packet and the control may be stored in a controller First In First Out (FIFO) in the data generator 320. That is, a page replacement algorithm may be used for a storing operation. Control information may include control information on nCS READ/WRITE and control information on Calibration Configuration register. Accordingly, the second controller 310 may find clock generation, Tx data, and data capturing timings sequentially according to an operation sequence. In this example, as shown in FIG. 5, the calibration configuration register or control information thereon may be formed on a part of controlling operations 500, a part of setting the number of iteration to find an optimum timing and an operation frequency 510, and an INT register for controlling interruption (INT EN) 520 as shown in FIG. 5.

The data capturing unit 330 operates under the control of the second controller 310 and reads data stored in the storage 130 which operates as the slave unit 160′, with changing a capturing timing. In addition, the data capturing unit 330 determines whether the read data is consistent with the pre-stored data and detects a capturing timing when the data are consistent. In this operation, the data capturing unit 330 may compare data which belong to the same address by one byte unit, for example. As the result, the data capturing unit 330 may detect a plurality of capturing timings. The data capturing unit 330 may detect a capturing timing in various methods, such as a method of determining an intermediate value as a valid capturing timing. The determined capturing timing becomes a calibration value with respect to a delay which occurs in a data processing operation.

As the result of the above operation, the second controller 310 knows the delay value which occurred internally through the data capturing unit 330, and thus, reads data from the storage 130 by reflecting the delay value.

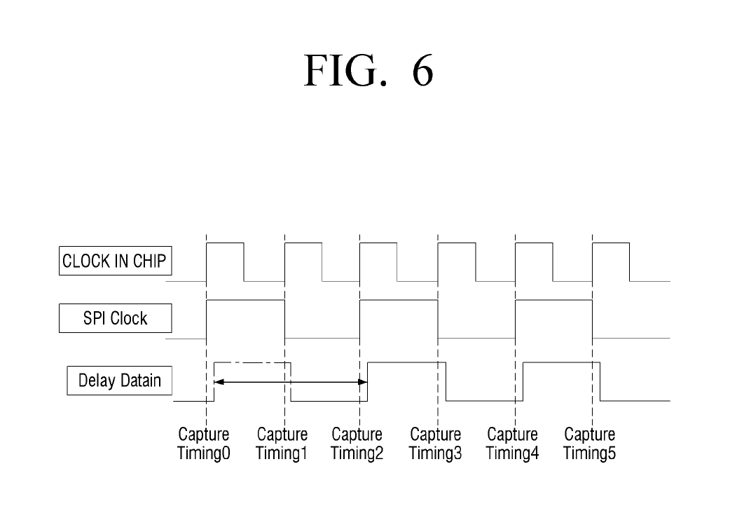

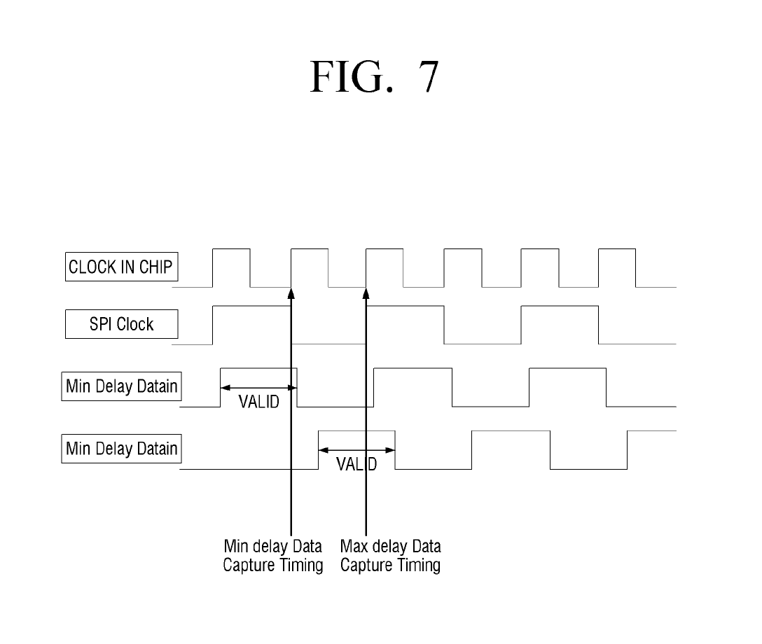

FIG. 6 is a diagram provided to describe a process of capturing data by changing a capturing timing, and FIG. 7 is a diagram provided to describe a process of differently setting a capturing timing according to an actual delay of a chip.

Referring to FIGS. 6 and 7 with FIGS. 2 and 3 for convenience in explanation, the master unit 120-2′ records a particular value in the slave unit 130′, and in response to the recorded value being read in the slave unit 130′, determines that the current capturing timing is valid. By contrast, in response to a different value, not the recorded value, being read, the master unit 120-2′ may determine that the capturing timing is incorrect.

Accordingly, in an exemplary embodiment, the master unit 120-2′ reads data with changing the capturing timing as shown in FIG. 6. In this example, changing the capturing timing may be available by controlling a delay in the chip by clock units, for example. It may be seen that the data capturing unit 330 in FIG. 3 substantially performs the operation of finding a valid capturing timing with changing a capturing timing.

In addition, even though chip are manufactured in the same process, a valid capturing timing may be different by chip. The difference may be caused by a manufacturing process, or may be caused by a delay on each route which is different by chip according to a position on a wafer. In an exemplary embodiment, a valid capturing timing may be set differently for each chip as shown in FIG. 7, and thus, there are merits of not reducing the SPI clock to use the common capturing timing.

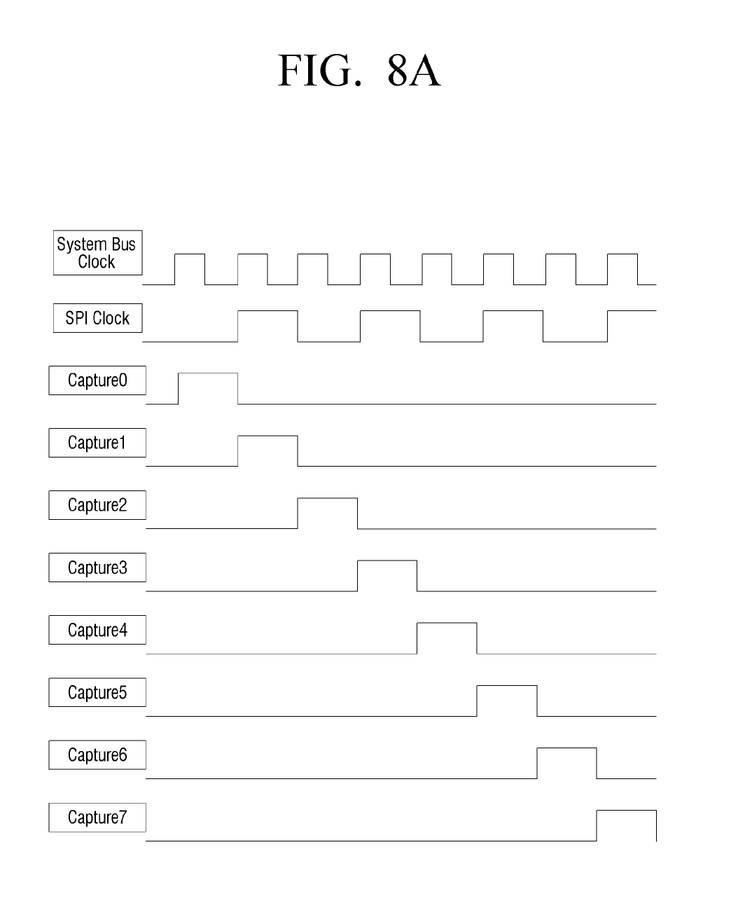

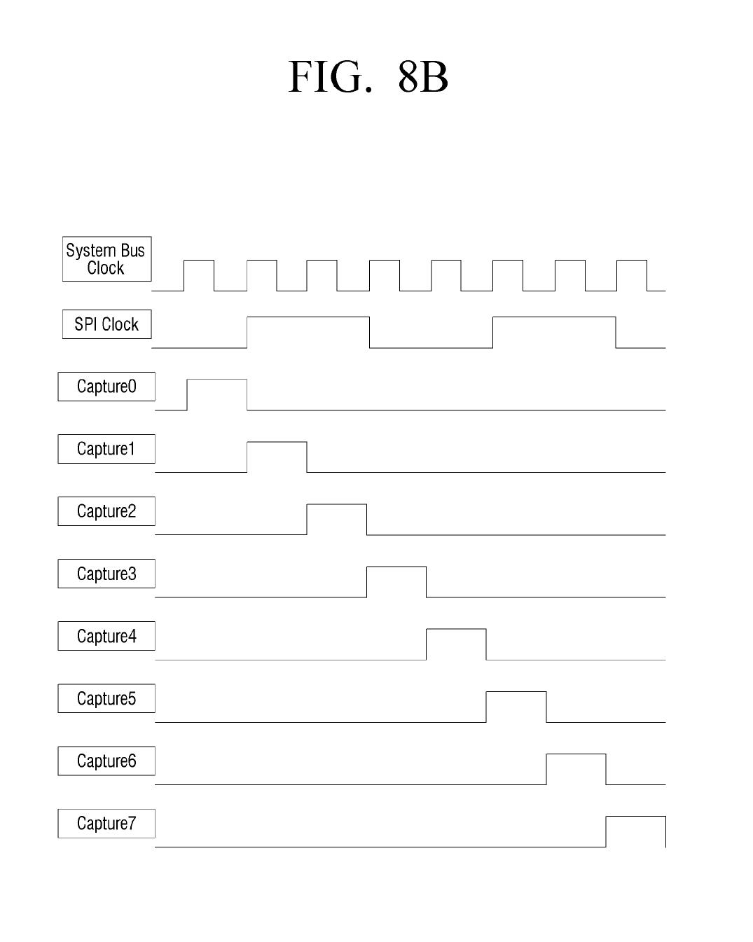

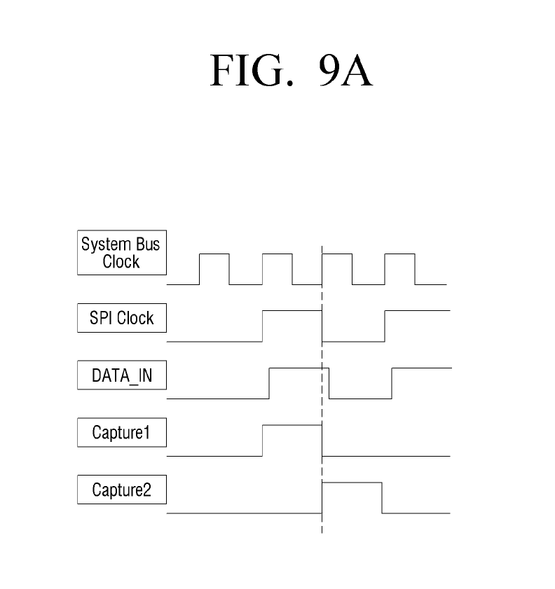

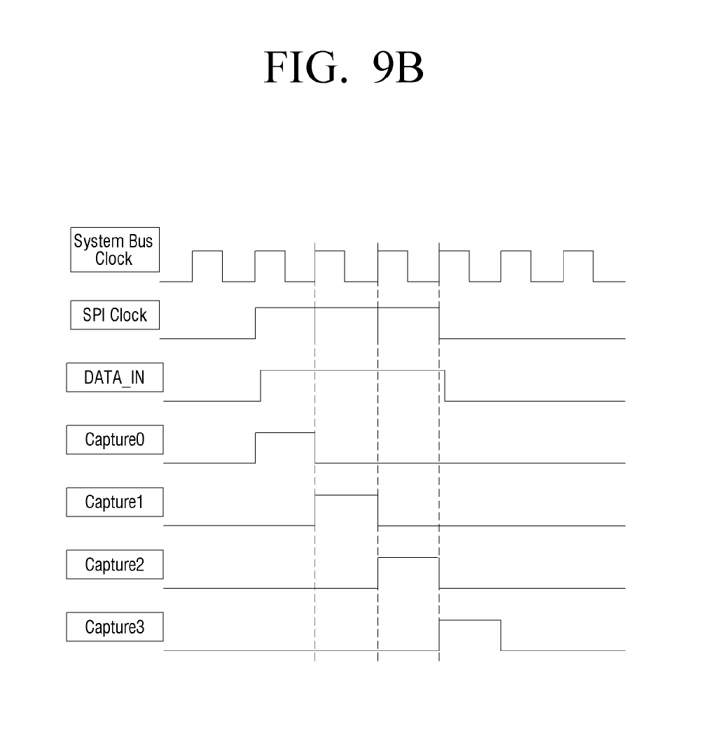

In response to a temperature being changed, a route delay in the chip is also changed. In an exemplary embodiment, a capturing timing may be determined by considering such characteristic. This operation will be described below with reference to FIGS. 8A to 9B.

FIGS. 8A and 8B are diagrams provided to describe a process of changing a clock cycle, that is, a duty ratio, by considering a temperature change, and FIGS. 9A and 9B are diagrams provided to describe a process of determining a valid capturing timing according to a change of a clock cycle.

If there is a sharp temperature change, reliability be may raised by selecting a SPI clock cycle, as six, when there are three valid capturing timings and selecting an intermediate value of a plurality of capturing timings as a valid capturing timing as shown in FIG. 9B rather than selecting a SPI clock cycle, as two, when there is one valid data capturing timing.

That is, in response to occurrence of the temperature change, the timing calibration unit 120-2 in FIG. 1 according to an exemplary embodiment. More, particularly, the data capturing unit 330 of FIG. 3 may detect a capturing timing with respect to data in the same address with changing the SPI clock cycle, that is, the duty ratio, as shown in FIGS. 8A and 8B. In this example, it may be seen that an optimum capturing timing is detected by using a capturing timing in the SPI clock cycle where many capturing timings are detected unless an upper limit value is exceeded.

For example, the timing calibration unit 120-2 in FIG. 1 finds a valid data capturing timing by comparing the data read by the SPI clock cycle. Data information for the comparison with the read data may be pre-stored in the storage 130 of FIG. 1. The timing calibration unit 120-2 stores the capturing timing and the SPI clock cycle, that is, information, when there is one valid data capturing timing, and finds a SPI clock timing where there are three valid capturing timings as shown in FIG. 9B with increasing the SPI clock cycle unless the upper limit value is exceeded as in FIGS. 8B and 9B. Subsequently, it is possible to receive a selection as to whether to use the capturing timing and the SPI clock cycle when there is one valid capturing timing or use the capturing timing and the SPI clock cycle when there are three valid capturing timings, according to a user setting.

The timing calibration unit 120-2 of FIG. 1 according to an exemplary embodiment may set a maximum clock value and a maximum timing value. In response to a capturing timing not being found after finding the timing to the preset maximum clock value and maximum timing value, the timing calibration unit 120-2 may generate an apparatus error interruption. If the recorded value has never been read when the data is read with changing the capturing timing after the data is recorded, it may be seen that the data read from the slave unit 130′ is not outputted normally. In this example, the timing calibration unit 120-2 generates an interruption and notifies that the apparatus does not operate normally to a Central Processing Unit (CPU), that is, the first controller 120-1. Accordingly, the first controller 120-1 may perform control with respect to a determined apparatus error.

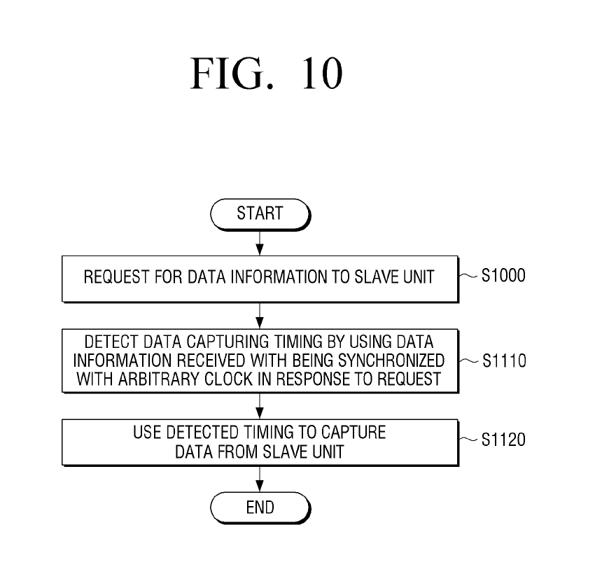

FIG. 10 is a flowchart provided to describe a method of driving an image forming apparatus according to an exemplary embodiment.

Referring to FIG. 10 with FIG. 1 for convenience for explanation, the image forming apparatus 90 according to an exemplary embodiment requests for data information to the communication interface 100 or the storage 130 which operates as the slave unit in FIG. 1, for example (S1000). Such request may occur when the image forming apparatus 90 is initially booted up, when an inner clock is changed, for example, such that a mode is switched to a power saving mode, or when a particular slave unit is selected or the selected slave unit is changed. In this example, the data information may include data which was transmitted from the master unit and stored in the slave unit or the apparatus ID or address information stored in the slave unit.

Subsequently, the image forming apparatus 90 detects a data capturing timing by using data information which is received with being synchronized with an arbitrary clock in response to a request (S1010). In detecting a data capturing timing, the image forming apparatus 90 reads data in the same address with changing a capturing timing and detects a capturing timing when the read data and the pre-stored data information are consistent with each other. In this example, the capturing timing may refer to time corresponding to an ascending edge of a system bus clock such as that shown in FIGS. 8 and 9. Such time may be measured by a timer or a counter.

The image forming apparatus 90 uses the detected capturing timing to capture data from the slave unit such as the storage 130 (S1120.) In other words, the image forming apparatus 90 knows the delay between the master unit and the slave unit through the timing detection operation, and thus, processes data to be read by considering such delay. For example, in reading or receiving data, the image forming apparatus 90 may read or receive the data after excluding the time or information on the delay.

In addition, as described above, the image forming apparatus 90 according to an exemplary embodiment performs calibration with respect to a capturing timing when the SPI master is used or the inner clock is changed after the initial boot-up operation. The first controller 120-1 of FIG. 1 turns on the timing calibration unit 120-2, for example, according to execution of the SW, and the timing calibration unit 120-2 or the second controller 310 in the timing calibration unit 120-2 awaits until the data capturing unit 330 finds a timing value. In this example, the image forming apparatus 90 supports an interruption mode, and thus, the timing calibration unit 120-2, more particularly, the second controller 310 finds a valid clock and timing with changing a clock cycle and a timing value after the calibration operation. The second controller 310 detects a valid value from among found values and transmits a calibration completion signal to notify that the SPI data transmission is available to the SW. For doing this operation, the image forming apparatus 90 according to an exemplary embodiment supports an interruption mode and a polling mode. Upon completion of the calibration, the image forming apparatus 90 performs the SPI data transmission.

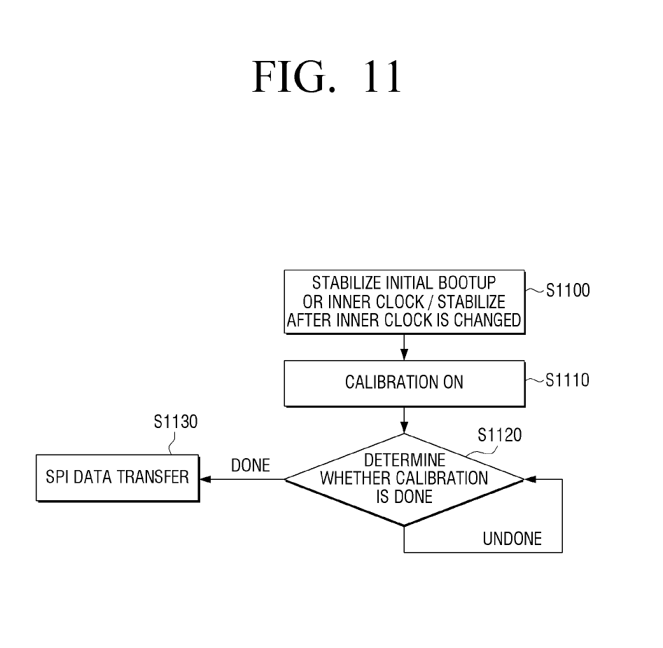

FIG. 11 is a flowchart provided to describe an operating process of an image forming apparatus which operates in a polling mode according to an exemplary embodiment.

Referring to FIG. 11 with FIG. 1 for convenience of explanation, the image forming apparatus 90 according to an exemplary embodiment determines whether an event for performing timing calibration occurs (S1100). For example, the image forming apparatus 90 may determine whether the apparatus is in the initial boot-up process or whether a mode of the apparatus is switched to a power saving mode.

In response to occurrence of the event for performing the timing calibration, the image forming apparatus 90 performs an operation for calibrating a data capturing timing (S1110).

Subsequently, the image forming apparatus 90 may determine whether the capturing timing calibration operation is completed, and in response to determining that the operation is completed, perform a data transmission operation for SPI communication (S1120, S1130).

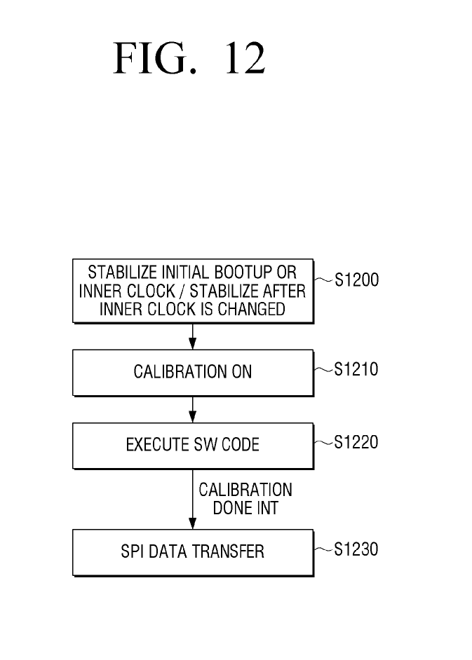

FIG. 12 is a flowchart provided to describe an operating process of an image forming apparatus which operates in an interrupting mode according to an exemplary embodiment.

Referring to FIG. 12 with FIG. 1 for convenience in explanation, the image forming apparatus 90 according to an exemplary embodiment determines whether an event for performing the timing calibration occurs as shown in FIG. 11, and in response to determining that the event occurred, performs an operation for calibrating a data capturing timing (S1200, S1210).

In this process, the image forming apparatus 90 executes a SW code for generating an interruption with the start of the calibration operation and generates an interruption upon completion of the calibration (Calibration Done INT) (S1220).

By the interruption, the image forming apparatus 90 may perform a data transmission operation for performing the SPI communication (S1230).

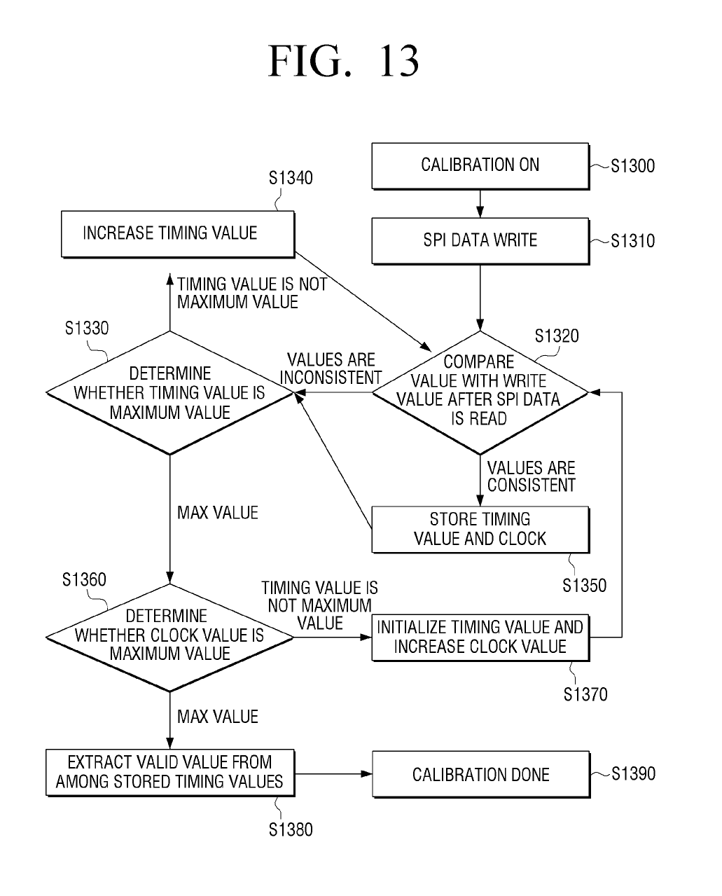

FIG. 13 is a flowchart provided to describe an operating process of an image forming apparatus according to an exemplary embodiment.

Referring to FIG. 13 with FIG. 1 for convenience in explanation, the image forming apparatus 90 according to an exemplary embodiment performs a capturing timing calibration operation when the initial boot-up operation is performed or the inner clock is changed (S1300). For example, the image forming apparatus 90 may be set so as to execute SW and generate a bit in response to occurrence of the event. Such operation may be a process of operating the timing calibration unit 120-2 after the first controller 120-1 of FIG. 1 determines the event.

According to the operation of the timing calibration unit 120-2, the image forming apparatus 90 may record data in the storage 130 which operates as a slave unit of the timing calibration unit 120-2 which operates as a master unit in order to perform the SPI communication, for example. (S1310).

Subsequently, the image forming apparatus 90 reads the recorded data and determines whether the read data is consistent with the recorded value (S1320). For example, the image forming apparatus 90 records ‘O×AA’ and reads the recorded data again in order to determine whether ‘O×AA’ is read. In an example of a valid timing, the recorded value and the read value are consistent with each other.

In response to determining that the recorded value and the read value are not consistent, the image forming apparatus 90 determines whether a timing value exceeds a maximum setting value, and if not, determines whether the recorded data and the read data are consistent again by increasing the timing value (S1330, S1340).

In response to the data being consistent with each other, the image forming apparatus 90 stores the timing value and clock information on a clock (S1350). In addition, the image forming apparatus 90 may proceed to S1330 to determine whether the timing value is a maximum value.

In response to a temperature change being sensed in performing the above process, the image forming apparatus 90 may change a clock and additionally determine whether the data are consistent with respect to data in the same address. Accordingly, in response to a clock being changed, the image forming apparatus 90 may determine whether a clock value exceeds a maximum setting value (S1360).

In response to the clock value not exceeding the maximum value, the image forming apparatus 90 may proceed to S1320 by initializing the timing value and increasing the clock value (S1370). By doing this, the image forming apparatus 90 detects a timing value with respect to a particular clock frequency.

In response to determining that the timing value exceeds the maximum value in S1360, the image forming apparatus 90 selects a stored timing value or a cycle having many timing values with respect to a particular cycle and finds a valid timing value by using a timing value of the selected cycle (S1380).

After the valid timing value is detected, the image forming apparatus 90 completes the timing calibration operation (S1390). Thereafter, the image forming apparatus 90 performs a data processing operation by using the detected valid timing value. That is, the image forming apparatus 90 processes data by calibrating the timing as much as the generated delay time.

According to an exemplary embodiment, it is possible to execute a timing calibration logic, for example, regardless of change of the inner clock or a delay in controlling the SPI, thereby preventing inconvenience of setting operations for calibration one by one. In addition, it is possible not to give margin to each example by using an actual measurement value, not an expected value as in the related art, and thus, data may be transmitted and received at a maximum speed that a master and a slave may provide.

Although one or more exemplary embodiments refer to a MODEM, facsimile or Wi-Fi communication, it is understood that aspects of the above-described embodiments may be implemented over a wired or wireless network, or a combination thereof. Any communication or network may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, Zigbee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like.

Although it has been described that entire components constituting one or more exemplary embodiments are combined as a single component or operate by being combined with each other, exemplary embodiments are not limited thereto. That is, unless it goes beyond the purpose of exemplary embodiments, the entire components may be selectively combined as one or more components. In addition, each of the entire components may be implemented as independent hardware. Alternatively, a part or all of the components may be selectively combined and implemented as a computer program having a program module which performs a part or all functions combined in one or a plurality of pieces of hardware.

Processes, functions, methods, and/or software in apparatuses described herein may be recorded, stored, or fixed in one or more non-transitory computer-readable storage media (computer readable recording medium) that includes program instructions (computer readable instructions) to be implemented by a computer to cause one or more processors to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. A universal serial bus (USB), memory card, Blu-ray disk, hard disk, and the like are some additional examples of non-transitory computer readable. Examples of program instructions include machine code, such as produced by a compiler, and files containing higher level code that may be executed by the computer using an interpreter. The program instructions may be executed by one or more processors. The described hardware devices may be configured to act as one or more software modules that are recorded, stored, or fixed in one or more computer-readable storage media, in order to perform the operations and methods described above, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA).

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. An image forming apparatus comprising:
a master unit configured to detect a data capturing timing by using data information received with being synchronized with an arbitrary clock in response to a request for data information for a slave unit and configured to use the detected data capturing timing to capture data of the slave unit; and
the slave unit configured to provide the data information which is synchronized with the arbitrary clock in response to the request for data information from the master unit.

2. The apparatus as claimed in claim 1, wherein:
the master unit and the slave unit perform Serial Peripheral Interface (SPI) communication, and
when the slave unit is a storage, the master unit reads data transmitted from the master unit and stored in the slave unit and uses the read data as the data information.

3. The apparatus as claimed in claim 1, wherein when the slave unit is a unit which is incapable of storing data, the master unit uses apparatus identification (ID) stored in the slave unit or address information stored in the slave unit as the data information.

4. The apparatus as claimed in claim 1, wherein in response to change of an inner clock of the image forming apparatus or in response to selection of the slave unit, the master unit detects the data capturing timing.

5. The apparatus as claimed in claim 4, wherein the master unit uses data which belongs to the same address in order to detect the data capturing timing.

6. The apparatus as claimed in claim 4, further comprising:
a controller configured to control the master unit,
wherein the master unit receives a signal regarding the change of the inner clock or the selection of the slave unit from the controller.

7. The apparatus as claimed in claim 1, wherein the master unit detects a plurality of data capturing timings and uses one of the plurality of detected data capturing timings as a valid data capturing timing.

8. The apparatus as claimed in claim 1, wherein the master unit comprises a clock generator configured to generate clocks in different cycles and detects the data capturing timing by using the data information regarding the generated clocks of different cycles.

9. The apparatus as claimed in claim 1, wherein the master unit pre-stores second data information which is the same as the data information and detects a data capturing timing by receiving the data information with changing a data capturing timing and comparing the received data information with the pre-stored second data information.

10. A method of driving an image forming apparatus comprising:
requesting data information from a slave unit;
detecting a data capturing timing by using the data information which is received with being synchronized with an arbitrary clock in response to the request; and
using the detected data capturing timing to capture data of the slave unit.

11. The method as claimed in claim 10, further comprising:
storing second data information which is the same as the data information; and
comparing the received data information with the stored second data information,
wherein the detecting the data capturing timing comprises detecting a timing when the received data information is consistent with the stored second data information as the data capturing timing.

12. The method as claimed in claim 10, wherein:
the slave unit performs Serial Peripheral Interface (SPI) communication with a master unit, and
the detecting the data capturing timing comprises reading data transmitted from the master unit and stored in the slave unit and using the data as the data information.

13. The method as claimed in claim 11, wherein when the slave unit is a unit which is incapable of storing data, the detecting the data capturing timing comprises using apparatus identification (ID) stored in the slave unit or address information stored in the slave unit as the data information.

14. The method as claimed in claim 11, wherein in response to change of an inner clock of the image forming apparatus or in response to a selection of the slave unit, a data capturing unit detects the data capturing timing.

15. The method as claimed in claim 14, wherein the detecting the data capturing timing comprises using data which belongs to the same address in order to detect the data capturing timing.

16. The method as claimed in claim 14, further comprising:
receiving a signal regarding the change of the inner clock or the selection of the slave unit from an external source by the master unit.

17. The method as claimed in claim 11, wherein the detecting the data capturing timing comprises:
detecting a plurality of data capturing timings; and
determining one of the plurality of detected data capturing timings as a valid data capturing timing.

18. The method as claimed in claim 11, further comprising:
generating clocks in different cycles,
wherein the detecting the data capturing timing comprises detecting the data capturing timing by using the data information regarding the generated clocks of different cycles.

19. At least one non-transitory computer readable recording medium storing computer readable instructions that control at least one processor, when executed to perform a method of driving an image forming apparatus, the method comprising:
requesting data information from a slave unit;
detecting a data capturing timing by using the data information which is received with being synchronized with an arbitrary clock in response to the request; and
using the detected data capturing timing to capture data of the slave unit.
